(19) United States
(12) Patent Application Publication
(10) Pub. No.: US 2012/0012734 A1
(43) Pub. Date: Jan. 19, 2012

(54) SUPPORT WITH SPACER FOR PLAIN DOUBLE FACE DISPLAY, WITH ARRANGEMENT IN SLIDING SYSTEM FOR AUTOMATIC BENDING AND OPENING

(76) Inventor: Chung Kwo Tzuo, Sao Paulo (BR)

(21) Appl. No.: 13/139,195

(22) PCT Filed: Dec. 24, 2008
(86) PCT No.: PCT/IB2008/055531

§ 371 Date: Sep. 23, 2011

(51) Int. Cl. F16M 13/00; F16B 47/00

(52) U.S. Cl. 248/683; 248/689

(57) ABSTRACT

‘Support with spacer for plain, double face display, with arrangement in sliding system for automatic folding and opening’, presenting support (1) with version in expansive system, with two facing and joint portions (2) and (3), foldable in buds (5) by means of creases (4), joined through the overlying of their common flaps (6) with cuttings, forming extreme hooks (7) through which elastic bands (8) are applied for strong tensioning of the arming hinges (9), equipped with creased swinging walls (10), which join, closing or expanding, for automatic opening of the support (1). In the second version, in pulling system, both joint facing portions (2a) and (3a) are joined by two joint flaps (21) which receive, through their cuttings (22) in the shape of hooks, the application of elastic band (8) whose opposite end is anchored in cutting (23) of one internal structural insert (24), through which the support (Ia) shall be activated, through pulling. In both versions, the support (1) and/or (Ia) receives the corresponding portions of spacers (17), fixed by latches (14) and slots (15) with sliding system between themselves, being that, on the spacers (17) are fixed respective display panels (18), forming the plain, double face displays (19).

The present description report refers to the invention patent request of a cardboard display (obtained by means of cutting and folding design), composed based on a support or ‘inside space’, with its two confronting portions forming a joint assembly by means of elastic strip action.

The support tensioning may be carried out by means of an arrangement of overlaid flap and arming hinges (in expansion system) or, in another version, in an arrangement of flaps and locking flaps combined to the application of structural inserts (in a pulling system).

Both facing portions of the joint support will receive the attachment by means of latches and slots from the respective portions of a spacer previously attached to the internal faces of the corresponding display panels, thus forming a display of two plain, foldable faces with automatic opening. The support may also be previously joined by the flaps of its facing portions to the overlaid flaps of the spacing element portions, both of them (support and spacer) working together, forming also the Swivel inside space to receive the display panels to equally compose the display of two plain, foldable faces, with automatic opening.

Through a movement compensation system between the latches and openings, a light sliding movement is obtained between the support and the spacing element for the display folding without resistance points, following the creasing of the display panels' buds and avoiding resistance in the creasing points, resulting therefore in the display totally plain surface (for storage and transportation). Upon arrival at the client's, the display automatically opens into its varied versions: through the arming hinges (in the expansion mode) or through the structural inserts (in pulling system), forming anyway structures (support+spacer) for overlaying of both display panels, which may receive thus several contours along its flaps, combined to the printed images, displaying effectively the advertisement on both faces.

### TECHNIQUE STATUS

The cardboard displays are known for advertisement segment use, and may be composed by one face, two faces or double face, obtained from cutting and creasing design.

Such displays are designed with creases so that after being unfolded by the user they are assembled, structured from a base element attached which guarantees its vertical positioning and allows the view of the advertisement to be displayed.

The double-face displays are mostly formed by two facing portions attached to each other so that after being unfolded by the user they bear an oval format. In order to keep the oval format, that is, the structuring, the portions may receive cardboard bands between its buds, attached by its flaps and equipped with central ‘tabs’ which, after dis-assembly, may be unfolded by user, forming mechanically-reinforced transoms, laid internally and which ensure the display structuring.

Anyway, the cutting and creasing designs have been improved long time, making it possible the display production—not only of one plain face or with two oval faces but in varied formats and configurations, such as in form of cube, in quadrangular, hexagonal configuration or further in form of gondolas and displays (through more complex designs), when they receive shelves for supporting heavy products.

Currently, based on totem kind displays, for instance, it is possible to build cardboard structures, attaching such units so as to form partitions, fair stands and numberless other types of constructions, with the advantage of printed advertisement inclusion already conveyed in the cutting and creasing designs.

It is obvious that such displays, depending on its complexity, require assembly knowledge by the manufacturer, for the construction of shelves and remaining portions, such as the components involving the structure of one display for instance. The assembly performed by the user sometimes does not work out and for being made in cardboard the incorrect introduction followed by the removal of one structuring element may affect the display stability and even its usage, by damaging the material (cardboard). Furthermore, the assembly by the user requires time and even additional expenses so that they may finally use said advertisement tool.

As time goes by it was necessary then to prevent the user from assembling such displays. For such, systems were created through the application of elastic elements in the cardboard preset points such as the flaps (from cutting and creasing designs) which allowed the display to be kept folded (in plain condition, held by one envelope or surrounding adhesive band and etc.), being thus stored and transported in piled units. Such displays, after traded, are simultaneously armed automatically after removal of surrounding band, that is, after unpacking, thanks to the action of elastic elements, being structured without the user interference.

The own depositor of the process in question designed the expansive-like hinge, which owns creased walls for joint, being tensioned by means of elastic bands fixed strategically with the overlaid flaps for joining the facing portions forming the display. Such hinges allow the display to fold and for usage, under the action of elastic bands, they expand its swinging walls, opening or arming automatically the display.

The plain, only face displays own a base on which they are structured and have the advantage in relation to the ordinary oval displays of receiving contours along their flaps so that such flaps mix with the printed image to be displayed, resulting in a different effect. For example, the picture of a woman may be printed in a plain surface, and her arm may be projected out of the display body, also duly printed according to the cutting and creasing design.

The plain two-faced displays themselves, which may display an advertisement from their both overlaid blades, that is, to be viewed from both sides, are united by one base, getting to the user already assembled or in portions, with the fittings duly indicated so that they are structured on site. Such displays own the advantage of receiving contours which compose an image (combined to the printing) in both sides, and may, therefore, display an advertisement through distinct contours for both faces.

After being structured by one base, both plain overlaid blades form an effective advertising tool. Such plain two-faced displays must also be unfolded by the user and assembled from a base, generally an attached assembly, which allows for its structuring. Also in such cases there may be assembly errors of its structuring base and equally if elements are attached improperly, the tool may become unstable (due to the cardboard little strength), resulting in losses, waste of time and display total damage.

The U.S. Pat. No. 4,235,032 shows a plain two-faced display equipped with a core center structure tensioned by elastic bands. Such kind of display has the inside space composed of two portions, upper and lower, to which coincide the lower and higher portions of the display panels. Such display effectiveness is doubtful because the panels armed directly from a structure of inside space create points of resistance in the common creases, making it difficult both the folding and the automatic activation.

### Patent Purpose

The inventor hereby exactly obtains a plain two-faced display in form of plain display panels, which are fixed in a sliding way, through the spacer, to a support or inside space, obtaining a novel system of folding and automatic opening.

For such, the support may present versions for automatic activation of the display panels (in expansive system or in pulling system), keeping, however, the same operation principle, which is the tensioning by means of elastic bands.

Thus, in its first version (in expansive system), the support is formed by two joint facing portions, foldable in buds by means of creases, being joined by overlaying of its common flaps with cuttings, forming extreme hooks through which the elastic bands are applied for strong tensioning of the arming hinges. The arming hinges own creased, swinging walls (joints, they close or expand) and may be applied internally or externally along the overlaid flaps of the support portions.

The support owns latches, in its both facing portions, which are attached to the slots of both portions of one spacer. Both portions of the spacer, in its turn, are already previously glued to the internal faces of the respective display panels. The support may also be joined by its both facing portions to the spacer corresponding portions by means of arming hinges, so that an assembly (support+spacer) receive later the attachment of the display panels.

In such expansive system version the arming hinges may be arranged anyway by means of the creases of its swinging walls, as well an arrangement between the support and the spacer can be performed working jointly to provide the support with oval, rectangular, trapezoidal, hexagonal conformation or other formats. The expansive system, with the spacer application, assures the display double face formed, its folding and the automatic assembly properties, after opening when delivered to the client, avoiding the problems mentioned above in the technique status.

After delivered to the client, the display will be armed by the performance of the expansive clamp of the arming hinges, under action of the elastic bands, causing the support to open in a sliding way against the spacer and consequently assembling automatically, although without points of resistance, the display panels, which remain duly structured.

In the second version (in a pulling system), both joint facing portions are also joined by their common overlaid flaps on the support joint side, Said joint flaps receiving, by means of their cuttings in form of hooks, the application of elastic band whose opposed end in anchored in a cutting of an internal structural insert. The internal structural insert, in its turn, owns in its free end means to fit into the slot of the overlaid flaps of the support locking side.

Also in such version, the support owns, in its both facing portions, latches which are attached to the slots of the spacer portions. The spacer portions, equally, are already previously attached to the internal faces of the display panels.

After delivered to the client, the support will be armed by the elastic band action, pushing the inserts to pull the locking flaps, structuring the support and, consequently, arming automatically the display panels, without points of resistance in the creases, thanks to the sliding system provided by the combination of latches and slots between the support and the spacer.

Therefore, in all its versions, the attachment of the respective display panel coincides of creases and buds, forming a plain two-faced display with all advantages of advertisement exhibition. Through the ‘gap’ studied between the latches and slots of coinciding portions of the support and the spacer, the display may be initially folded without resistance in relation to the creases, to be stored in stacks, transported and finally delivered to the client for usage, following its automatic activation (carried out equally without resistance in relation to the creases).

Explained superficially, the display passes by two plain, foldable faces, of automatic opening, to be further detailed through the attached drawings.

The figures below related from 1 to 10 refer to the display in the version of the support armed by expansion system, with arming hinge under action of elastic bands:

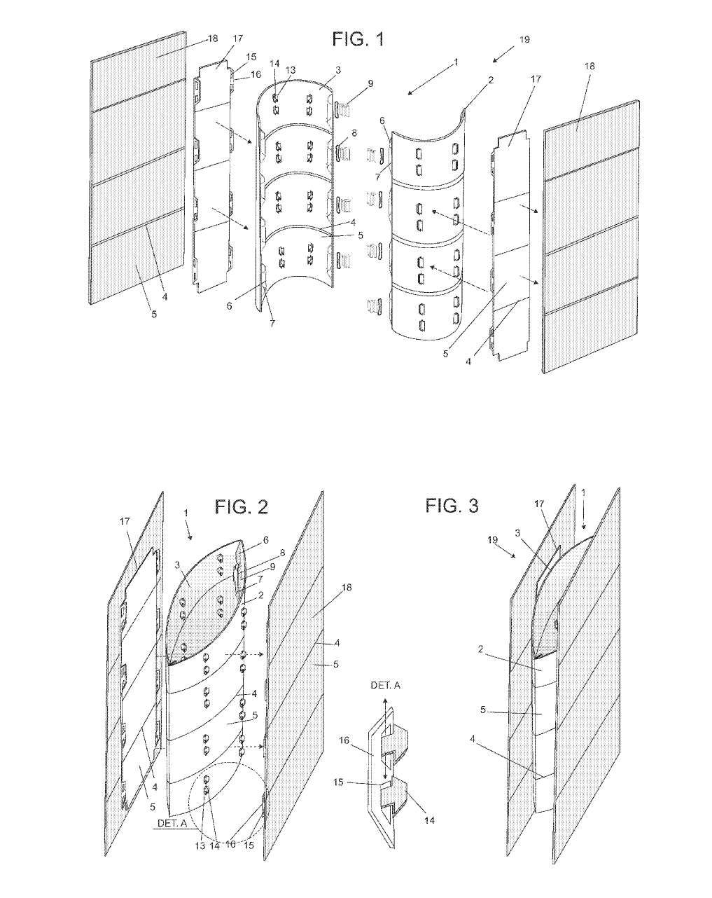

FIG. 1—Expanded perspective view of the plain two-faced display, showing both facing portions of the support in elliptic configuration, equipped with latches for coupling to the slots of both spacer corresponding portions. The spacer portions are previously attached to the internal faces of each display panel and then they receive the attachment, through its slots, of the support latches, forming the plain double face display;

FIG. 2—Perspective view, as to prior figure anterior, showing both facing portions of the elliptic support, joined and tensioned by the arming hinges under the action of elastic bands. In such view the attachment direction of the spacer portions is indicated, portions which are already attached to the internal faces of the display panels. Below, widened detail ‘A’ showing the ‘gap’ between the latch and the slot, forming a movement compensation system which allows for a light sliding between the support and the spacer, avoiding points of resistance upon display folding, making it more effective its automatic activation;

FIG. 3—Perspective view, as to prior figure, showing the plain, double face display, assembled on the elliptic support attached to the spacer;

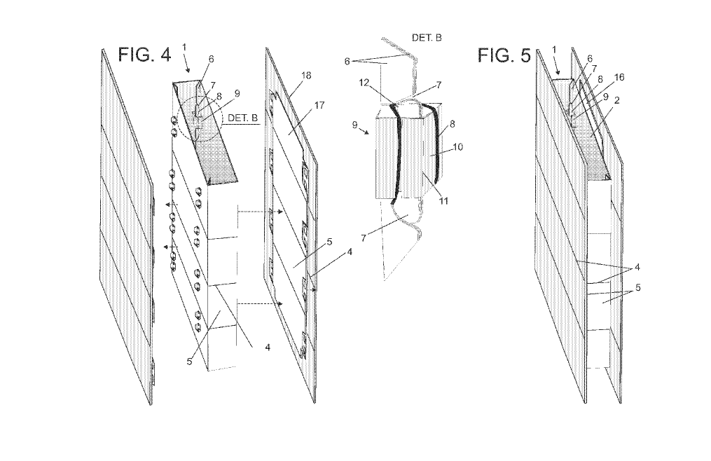

FIG. 4—Expanded perspective view, showing both facing portions of the rectangular support, joined and tensioned by the arming hinges under the action of the elastic bands. In such view the attachment direction of the spacer portions is indicated, portions which are already attached to the internal faces of the display panels. The hinge, by means of the creases of its swinging walls, become rectangular, transferred to the joint support of the double face display panels. Next to it, enlarged detail ‘B’ of the arming hinge, fixed to the support overlaying flaps, with its swinging walls tensioned by the elastic band ampliado da dobradiça de armar, mostrando as bordas de suas paredes molejantes vincadas, estando presa a receber alejantes, tom;

FIG. 5—Perspective view, as to prior figure, showing the plain, Double face display, assembled on the support in rectangular configuration;

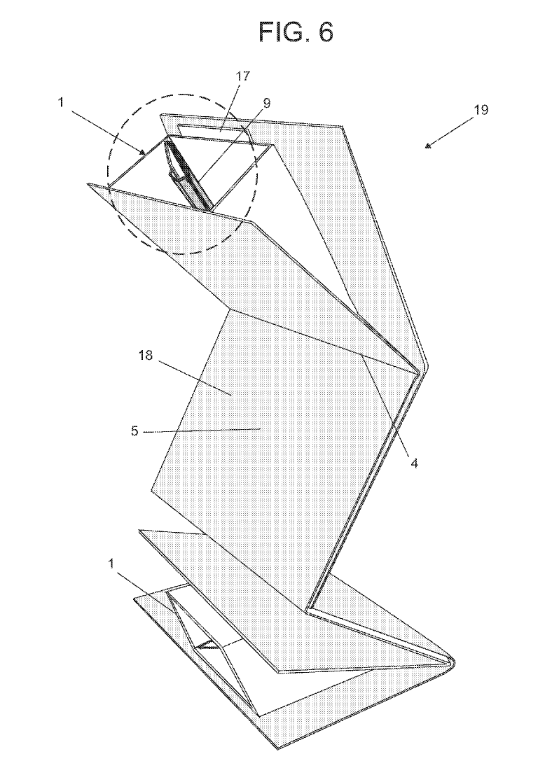

FIG. 6—Perspective view of the plain, double face display, folded or armed. As noted, the panels have the crease movements followed by the support and spacer creases;

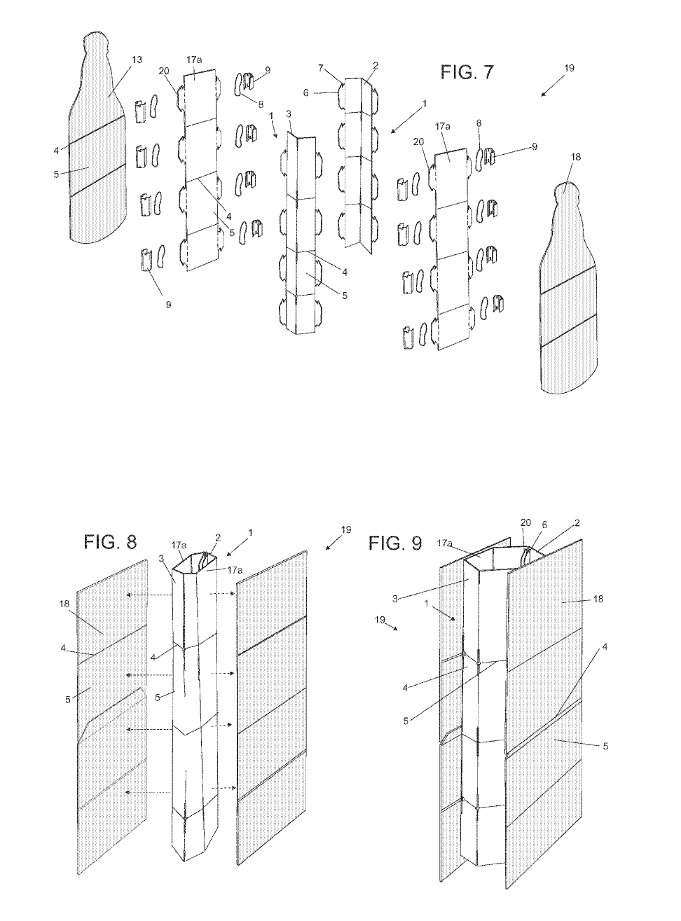

FIG. 7—Expanded perspective view, showing the support and the spacer, optionally with their overlaid flaps, joined by the arming hinges under elastic band tensioning. In such option, the support and spacer work together, forming a support which will receive later the display panels;

FIG. 8—Perspective view, as to prior figure, showing the support and spacer previously joined to receive the display panels;

FIG. 9—Perspective view, as to prior figure, showing the plain two-faced display, already assembled, in the version with support and spacer joined, in hexagonal configuration, for application into assembly, as support for automatic activation of the display panels;

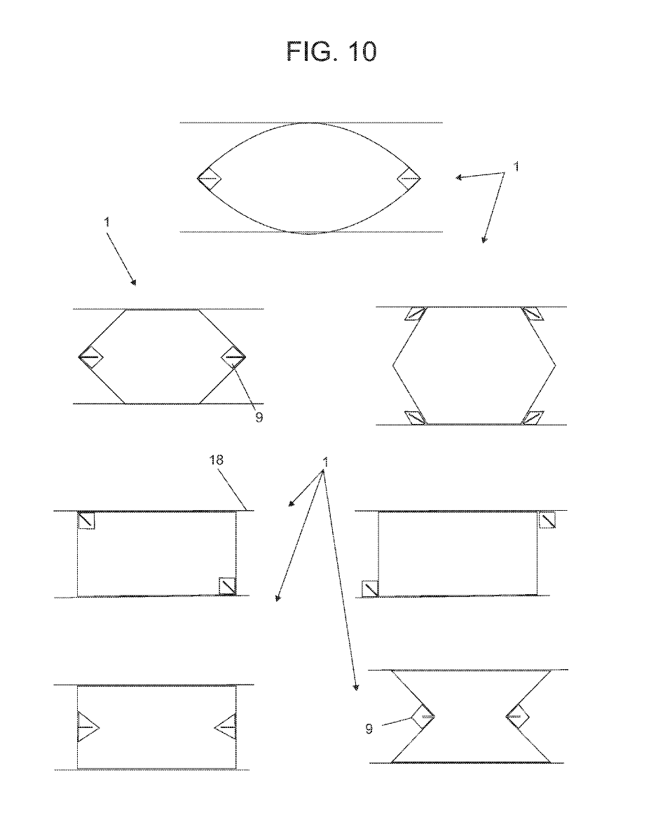

FIG. 10—View in plans of the several support configurations made possible as to the creasing of the swinging walls of the arming hinge and its positioning in relation to the support, spacer and display panels. As noted, the support may have elliptic, hexagonal, rectangular, square configuration, combined to the spacer, and the hinges may be applied internally or externally to the supports.

The figures below from 11 to 14 refer to the display in the version of the support armed by pulling, with structural insert under action of the elastic bands:

FIG. 11—Perspective view of the plain, two-faced display, assembled;

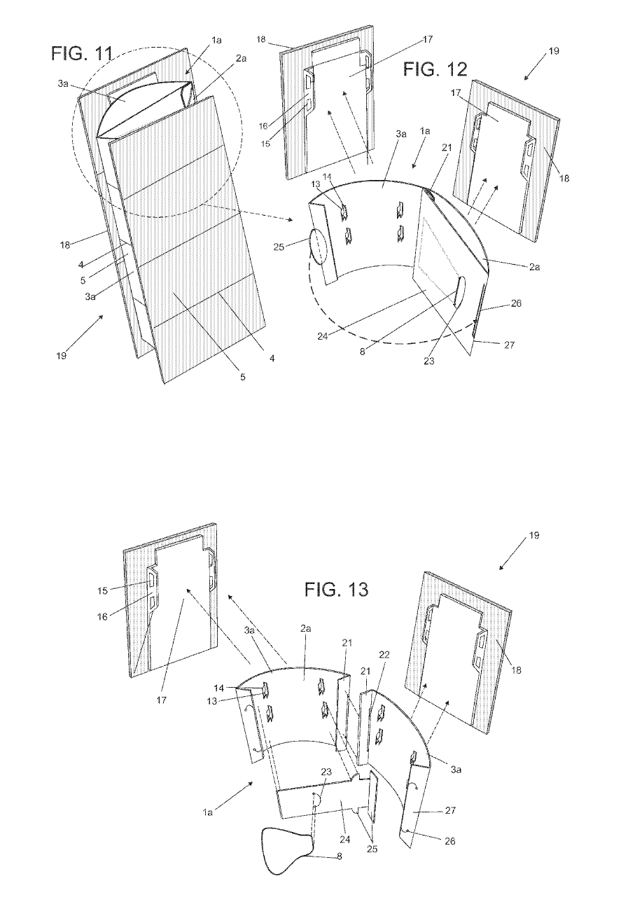

FIG. 12—Expanded perspective view, as to prior figure, showing a bud of the display equipped with structural insert for the pulling system for automatic activation, being indicated the attachment of the latches of the support facing portions to the spacer portions' slots, in its turn attached to their respective display panel;

FIG. 13—View as to prior figure, showing a structural insert variation;

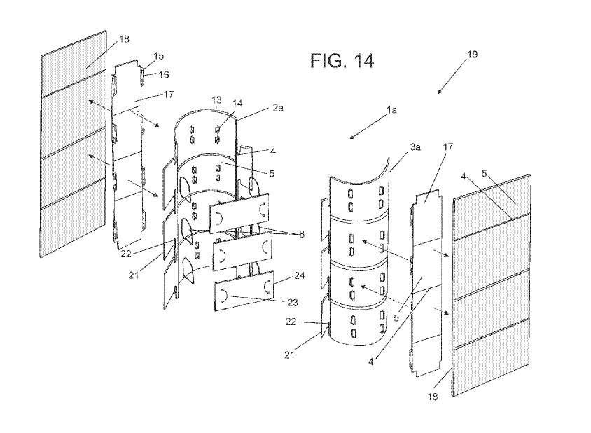

FIG. 14—Display enlarged view, showing the attachment between the latches and slots for the sliding system, as well as the structural inserts and the display panels which shall be folded and opened by the automatic activation system through pulling. In such view, the structural inserts own cuttings on both sides, which shall be tensioned by the elastic bands anchored from the joint flaps' cuttings of the facing portions.

In compliance to the drawings attached hereto, the ‘SUPPORT WITH SPACER FOR PLAIN, DOUBLE FACE DISPLAY, WITH ARRANGEMENT FOR SLIDING SYSTEM FOR AUTOMATIC FOLDING AND OPENING’, object of the present invention patent request, is made from one support (1) formed by two portions (2) and (3) manufactured in cardboard, through cutting and creasing design, crease receptor (4), from which the foldable buds (5) are obtained.

In the first version, both facing portions (2) and (3) of the support (1) incorporate flaps (6) along their side flaps, being equipped with cuttings forming hooks (7) in their opposite ends. Both facing portions (2) and (3) are united jointly between themselves by elastic bands' application (8), passing through the hooks (7) of the overlaid flaps (6). The elastic bands (8) hold and tension, also, respective arming hinge (9). As shown by Detail ‘B’ of FIG. 4, each arming hinge (9) owns format of tube of quadrangular section, having walls (10) creased (11), forming joint vertex, being one of such vertexes cut (12), so as to provide total flexibility to its walls (10) (swinging walls), upon the action of the elastic band (8).

Therefore both facing portions (2) and (3) are arranged for automatic activation due to expansion of hinges (9), providing the support (1) with varied formats such elliptic, shown in FIGS. 1, 2 and 3 and quadrangular, rectangular or similar, shown in FIGS. 4, 5 and 6.

Both facing portions (2) and (3) receive, in their external faces, a series of cuttings (13) which originate latches (14), aligned and coincident to the slots (15) formed in tracks (16) of the portions of one spacer (17). The portions of one spacer (17) shall be attached directly to the internal faces of the respective display panel (18), as shown in FIG. 1, composing thus the plain, double face display (19).

The same support (1), in constructive option shown in FIG. 7, may receive through the flaps (6) of its both facing portions (2) and (3), the overlying of flaps (20) in identical conformation, incorporated to the spacer portions (17a), said portions equally equipped with coinciding creases (4) and buds (5). Through the overlaid flaps (6) and (20), the support (1) is joined to the spacer (17a), through the arming hinges (9), as shown in FIG. 8, working jointly (support+spacer), forming a hexagonal support (1) which shall receive the attachment of the display panels' internal faces (18), as shown in FIG. 9.

This way, in this first version, the hinge (9) when applied internally to the support (1) is laid so as to touch the swinging walls (10), pushing them against internal faces of the facing portions (2) and (3). When applied externally to the support (1), the hinge (9) touches one of its walls (10) in the display panel (18) and the contiguous wall (10) touches the support (1). In both cases, the walls (10) of the hinge (9) are pushed by their flaps against the overlaid flaps (6) and (20) of the support (1), so as to cause in such spot a strong tension by the action of the elastic band (8), triggering the expansion system.

With such arrangement, the folded display (19), after delivered to the client shall be activated by the performance of hinges (9), whose swinging walls (10), pressed by the elastic band (8) open through the cutting (12), in a system of expansive clamp, pushing both the support (1) and the display panel (18), as shown in FIG. 6. Therefore, the support (1) opens and, consequently, the plain two-face display (19) is activated, structuring the display panels (18) without any problem as regards the occurrence of points of resistance in the creasing, since the sliding system between the latches and slots guarantees the cardboard preservation.

According to the arrangement of the creases (11) of the walls (10) of the hinge (9), the hinge may take different geometric configurations such as rectangular, square, hexagonal, oval and others, determining thus, the format of the support (1) for the plain, two-faced display (19), as shown in FIG. 10.

In a second version, for the pulling system, as shown initially in FIGS. 11 and 12, both facing portions (2a) and (3a) of the support (1a) own each a side portion of joints formed by joint flaps (21) with cuttings (22) in their ends, through which the respective elastic band (8) passes, whose opposite end is fixed to the cutting (23) of one internal structural insert (24). As shown in FIG. 13, the structural insert (24) may be equipped with attachment in the shape of a locking latch (25) and corresponding cuttings (26) performed in the locking flaps (27), causing, by means of pulling, the closure of both portions (2a) and (3a) in its locking side portion, forming the joint support (1a). As shown in FIG. 14, the structural insert (24) may present cuttings (23) in its ends, to which the elastic bands (8) are attached, anchored on the cuttings (22) of the joint overlaid flaps (21) of the facing portions (2a) and (3a).

Furthermore, both facing portions (2a) and (3a) also receive, in their external faces, the cuttings (13) which originate the latches (14), aligned and coincident to the slots (15) of the tracks (16) of the spacer (17) portions. Following the same principle of expansive system, the spacer (17) portions shall be attached directly to the internal faces of the respective display panel (18) and then by the latches (14) and slots (15), attached to the portions (2a) and (3a) of the support (1a), composing also the plain, double face display (19).

In such second version, after delivered folded to the client, the display (19) shall be armed by the action of the elastic bands (8) which, from the joint flaps (21), push the structural inserts (24) for pulling of the joint flaps (21) and locking flaps (27), providing the support (1a) with the oval configuration and consequently activating the plain, double face display (19), with the display panel structuring (18).

As shown in Detail ‘A’ of FIG. 2, the display (19) owns a movement compensation system between the latches (14) and the union slots (15) between the supports (1) and (1a) and spacers (17) respectively.

Besides the crease coincidence (4) and buds (5), the supports (1), (1a) and spacers (17) slide lightly between themselves, following and avoiding possible points of resistance during panel folding (18), as shown in FIG. 6, allowing the automatic closure and activation several times, without prejudice of the material (cardboard), providing total flexibility to the display (19).

1-6. (canceled)

7. A support with spacer for plain, double face display, made up from a support formed by two portions and creased, with foldable buds, said facing portions and incorporating side flaps with cuttings in the shape of hooks in their opposite ends, receptors of the elastic band of tensioning and fixation of arming hinge, which is formed by swinging walls creased, having a cut vertex in a shape of expansive clamp, said portions characterized by receiving externally in their surfaces a series of cuttings which originate latches, aligned and coincident to slots formed in tracks of corresponding portions of a spacer, said portions of said spacer previously attached to corresponding internal faces of plain display panels, forming a plain, double face display.

8. The support with spacer for plain, double face display, according to claim 7, the support having its portions joined by a joint side portion formed by joint flaps with cuttings in its ends, through which the respective elastic band passes, whose opposite end is fixed to cuttings of internal structural inserts, equipped with attachment to cuttings of locking flaps, characterized by the portions receiving, in their surfaces, cuttings with latches, aligned and coincident to the slots of the tracks of the corresponding portions of the spacer, said portions of said spacer previously attached to the internal corresponding faces of plain display panels, forming a plain, double face display.

9. The support with spacer for plain double face display of claim 7, characterized by the spacer, already previously attached to the plain display panel, receiving, through the slots of its tracks the lock of latches of the supports.

10. The support with spacer for plain double face display of claim 8, characterized by the spacer, already previously attached to the plain display panel, receiving, through the slots of its tracks the lock of latches of the supports.

11. The support with spacer for plain double face display of claim 7, characterized by a certain gap between the latches and slots of the tracks of attachment between the supports and their respective spacers already previously attached to the display panels.

12. The support with spacer for plain double face display of claim 8, characterized by a certain gap between the latches and slots of the tracks of attachment between the supports and their respective spacers already previously attached to the display panels.

13. The support with spacer for plain double face display of claim 9, characterized by a certain gap between the latches and slots of the tracks of attachment between the supports and their respective spacers already previously attached to the display panels.

14. The support with spacer for plain, double face display, characterized , according to claim 7, by the facing portions equipped with creases and buds of the support, receiving, through their side flaps, the overlying of identical side flaps of the portions of the spacer, said portions equally equipped with creases and buds coincident, being the overlaid flaps, joined through the arming hinges, forming the support assembly.

15. The support with spacer for plain, double face display, according to claim 7, characterized by the support being joined to the spacer through the arming hinges, forming an assembly/support attached, for its later fixation with glue, to the internal faces of the plain display panels, forming a plain, double face display.

16. The support with spacer for plain, double face display, according to claim 14, characterized by the support being joined to the spacer through the arming hinges, forming an assembly/support attached, for its later fixation with glue, to the internal faces of the plain display panels, forming a plain, double face display.
